(19) United States
(12) Patent Application Publication
(10) Pub. No.: US 2015/0255847 A1
(43) Pub. Date: Sep. 10, 2015

(54) COPLANAR WAVEGUIDE (CPW) MICROWAVE TRANSMISSION LINE STRUCTURES

(71) Applicant: Raytheon Company, Waltham, MA (US)

(72) Inventors: Shahed Reza, Boxborough, MA (US); Keith R. Kessler, Andover, MA (US); Christopher M. Laighton, Boxborough, MA (US)

(73) Assignee: RAYTHEON COMPANY, Waltham, MA (US)

(21) Appl. No.: 14/196,678

(22) Filed: Mar. 4, 2014

(51) Int. Cl. H01P 3/02

(52) U.S. Cl. CPC H01P 3/026

(57) ABSTRACT

A microwave structure having an input section for receiving both a common mode signal and a CPW differential mode signal; an output section; and a CPW transmission line, having a center conductor disposed between a pair of coplanar ground plane conductors, connected between the input section and the output section. The conductors of the CPW transmission line are configured to provide the common mode signal a different attenuation in passing to the output section than the CPW transmission line provides to the differential mode signal passing between the input section and the output section.

### TECHNICAL FIELD

This disclosure relates generally to microwave transmission lines and more particular to coplanar waveguide (CPW) microwave transmission lines to provide a different attenuation to an unwanted mode of propagation from that provided to a desired mode of propagation.

### BACKGROUND

As is known in the art, a coplanar waveguides (CPW) structure includes: a center conductor disposed over a surface of a substrate; and a pair of ground plane conductors disposed over the surface of the substrate, the center conductor being disposed between the pair of ground plane conductors. Microwave energy fed to an input of the CPW propagates to an output in a differential transmission mode relative to the pair of ground plane conductor with the electromagnetic field being near the surface substrate. CPW has been and continue to being used in wide variety of integrated circuit and circuit board applications. However, being a three conductor system, CPW structures are vulnerable to propagation of unwanted common mode(s). For example, in many applications the integrated circuit having active elements interconnected on a top, or upper, surface of a common substrate and a conductor is disposed on the bottom surface of the substrate for mounting to a heat sink or to a system ground conductor, for example. In this example, a parallel plate region is formed between the conductors on the upper surface, particularly, when larger ground plane conductors are used for the CPW transmission line, and the conductor on the bottom surface.

More particularly, a microwave parallel plate region includes a pair of conductors disposed over opposite surfaces of a substrate. When such parallel plate region is used as a portion of a microwave transmission line, unwanted, parasitic, parallel plate modes may be generated (moding), supported between the pair of conductors, and then transmitted through the parallel plate region. In one application, a substrate may be used to realize a Monolithic Microwave Integrated Circuit (MMIC) chip having an amplifier with a conductor on the bottom of the substrate, for providing a system ground or for soldering to a printed circuit board or heat sink, for example, and conductors on the top of the substrate. In such chip, transmission lines are used to interconnect elements of the amplifier. As a result of the top and bottom conductors, parallel plate moding may be generated. If the generated moding has frequencies within the bandwidth of the amplifier with magnitudes equal to, or greater than, the forward gain of the amplifier, a portion of the output energy produced by the amplifier may be coupled back to the input of the amplifier providing positive feedback thereby generating unwanted oscillations.

Common mode generation may also result from interference from other sources, such as, for example, coupling of external signals generated by other sources, unbalanced excitation or unbalanced ground paths.

Thus, while CPW transmission uses a differential mode transmission, these other sources can generate common modes that can propagate through the CPW transmission lines as unwanted signals and become a source of parasitic unwanted common mode signals that propagate through the one or more of the center conductors and pair of ground plane conductors and adversely affect the performance and operation of the MMIC.

### SUMMARY

In accordance with the present disclosure, a transmission line structure is provided having: a substrate; and a coplanar waveguide transmission line disposed over a surface of the substrate. The coplanar waveguide transmission line includes: a center conductor disposed over a surface of the substrate; and a pair of ground plane conductors disposed over the surface of the substrate, the center conductor being disposed between the pair of ground plane conductors. The coplanar waveguide structure is configured to provide a different attenuation to an unwanted mode of propagation from that provided to a desired mode to propagate.

In one embodiment, the undesired mode is a common mode of propagation and the desired mode is a differential mode of propagation.

In one embodiment, at least one of the center conductor and the pair of ground plane conductors is configured as an inductor reactive element.

In one embodiment, the pair of ground plane conductors and the center conductor is each spiral shaped.

In one embodiment, the pair of ground plane conductors and the center conductor is each a meander line.

In one embodiment, each one of the center conductor and pair of ground plane conductors provides an inductor to suppress parasitic common mode signal propagation in the center conductor or in either one, or both, of the pair of ground plane conductors.

In one embodiment, a microwave structure includes: an input section for receiving both a common mode signal and a CPW differential mode signal; an output section; and a CPW transmission line, having a center conductor disposed between a pair of coplanar ground plane conductors, connected between the input section and the output section. The conductors of the CPW transmission line are configured to provide the common mode signal a different attenuation in passing to the output section than the CPW transmission line provides to the differential mode signal passing between the input section and the output section.

In one embodiment, the center conductor and the pair of ground plane conductors are each configured as an inductor.

In one embodiment, a capacitor is connected in parallel with the inductor.

With such an arrangement, the structure presents different impedances to the desired differential mode and the unwanted common mode. The structure provides attenuation of the unwanted common mode while allowing the desired differential mode to propagate. Thus, the structure appears as a spiral inductor to the common mode while appears as a matched transmission line to the differential mode. The structure can be used alone or part of a resonant circuit to block the common model leaving the differential mode transparent to the resonant circuit,

The structure serves as a choke to common mode microwave signals and a CPW transmission line for differential mode microwave signals.

In one embodiment, a resistor is connected in parallel with the inductor.

The resistor is used for dissipating the energy of the unwanted mode signal.

The details of one or more embodiments of the disclosure are set forth in the accompanying drawings and the description below. Other features, objects, and advantages of the disclosure will be apparent from the description and drawings, and from the claims.

### DESCRIPTION OF DRAWINGS

FIG. 1 is a an isometric sketch of a transmission line structure according to the disclosure;

FIG. 1A is an enlarged isometric sketch of a portion of the transmission line structure of FIG. 1, such portion being in the area designated by the arrow 1A-1A in FIG. 1;

FIG. 1B is a cross sectional, elevation view of a portion of the transmission line structure of FIG. 1, such cross section being taken along line 1B-1B in FIG. 1;

FIG. 2 is an isometric sketch of a transmission line structure according to another embodiment, of the disclosure;

FIG. 3A is a schematic diagram of a differential mode equivalent circuit of the transmission line structure of FIG. 2; and

FIG. 3B is a schematic diagram of a common mode equivalent circuit of the transmission line structure of FIG. 2.

Like reference symbols in the various drawings indicate like elements.

### DETAILED DESCRIPTION

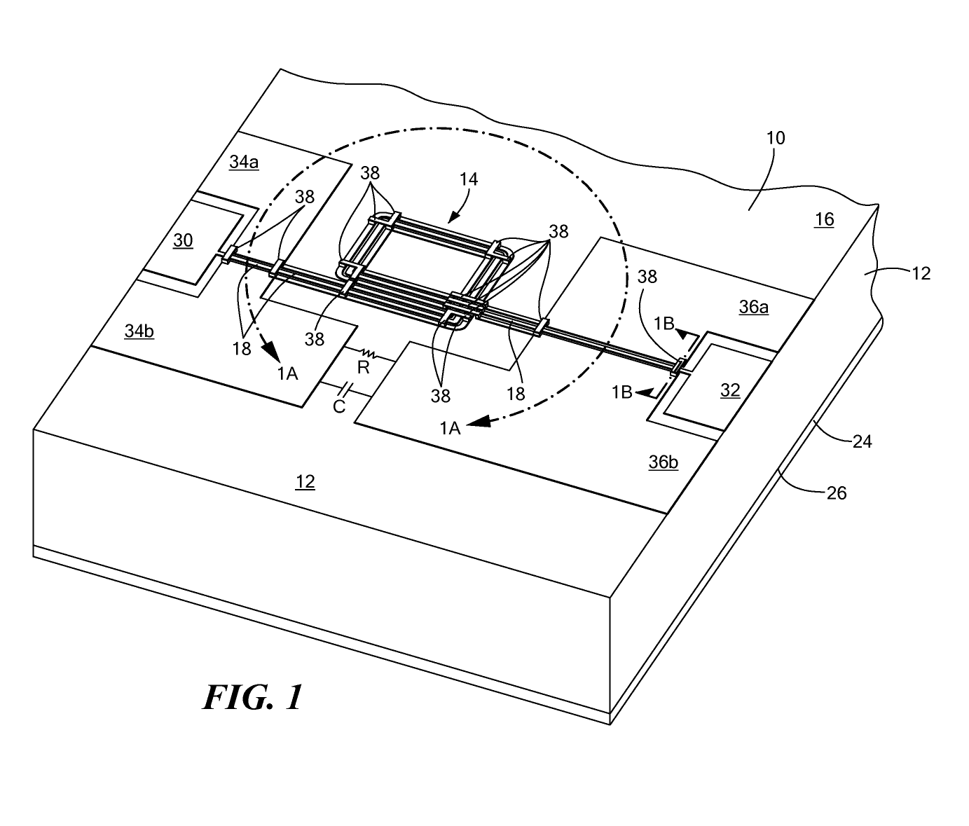

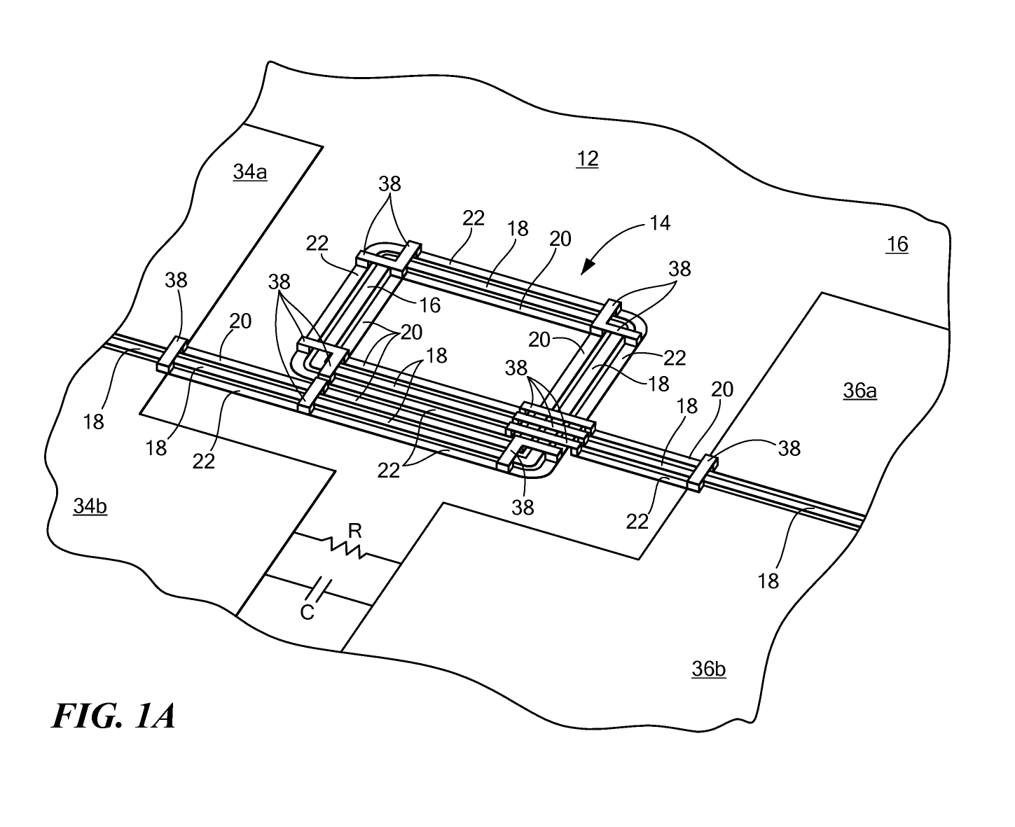

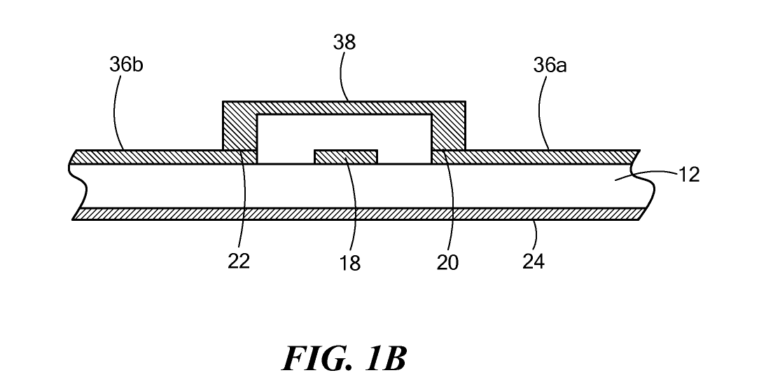

Referring now to FIGS. 1, 1A and 1B, a transmission line structure 10 is shown having: an insulating substrate 12 and a coplanar waveguide transmission line 14 disposed over an upper surface 16 of the substrate 12. The coplanar waveguide transmission line 14 includes: a center conductor 18 disposed over the upper surface 16 of the substrate 12; and a pair of ground plane conductors 20, 22 disposed over the upper surface 16 of the substrate 12, the center conductor, or signal line, 18 being disposed between the pair of ground plane conductors, or strips, 20, 22, as shown. At least one of the center conductor 18 and the pair of ground plane conductors 20, 22 is configured as a passive reactive element; here all three conductors 18, 20 and 22 are shaped as a spiral inductor, as will be described. It is noted that here a conductor 24 is disposed on the bottom surface 26 of the substrate 12. Here, the conductor 24 is used for mounting the structure 10 to a heat sink, not shown.

More particularly, the input to the coplanar waveguide transmission line 14 includes a center conductor input pad 30 connected to one end of the center conductor 18 and a center conductor output pad 32 connected to the other end of the center conductor 18. One end of both ground plane conductors 20, 22 is connected to a corresponding one of a pair of input ground plane pads 34a, 34b, respectively, as shown, and the other end of each one of the ground plane conductors 20, 22 is connected to a corresponding one of a pair of output ground plane pads 36a, 36b, respectively, as shown. It is noted that the ground plane conductors 20, 22 are connected by air-bridges 38 that span over the center conductors 18, as shown. The structure 10 may be formed using conventional photolithographic-etching processes.

As noted above, at least one of the center conductor 18 and the pair of ground plane conductors 20, 22; here all three conductors 18, 20 and 22 are shaped as a spiral inductor.

The spiral inductors are to provide an impedance to the common mode signals to suppress such common mode signals in attempting to pass between the input pad 30 and the output pad 32; however, the three conductors 18, 20 and 22 forming a CPW transmission line, allow differential mode signals at the input pad 30 to pass to the output pad 32 substantially unattenuated. Thus, the structure resembles a spiral inductor, however unlike the common spiral inductor where the signal line only wraps around, in structure two ground conductor strips 20, 22 also follow the signal line 18 and wraps around as well.

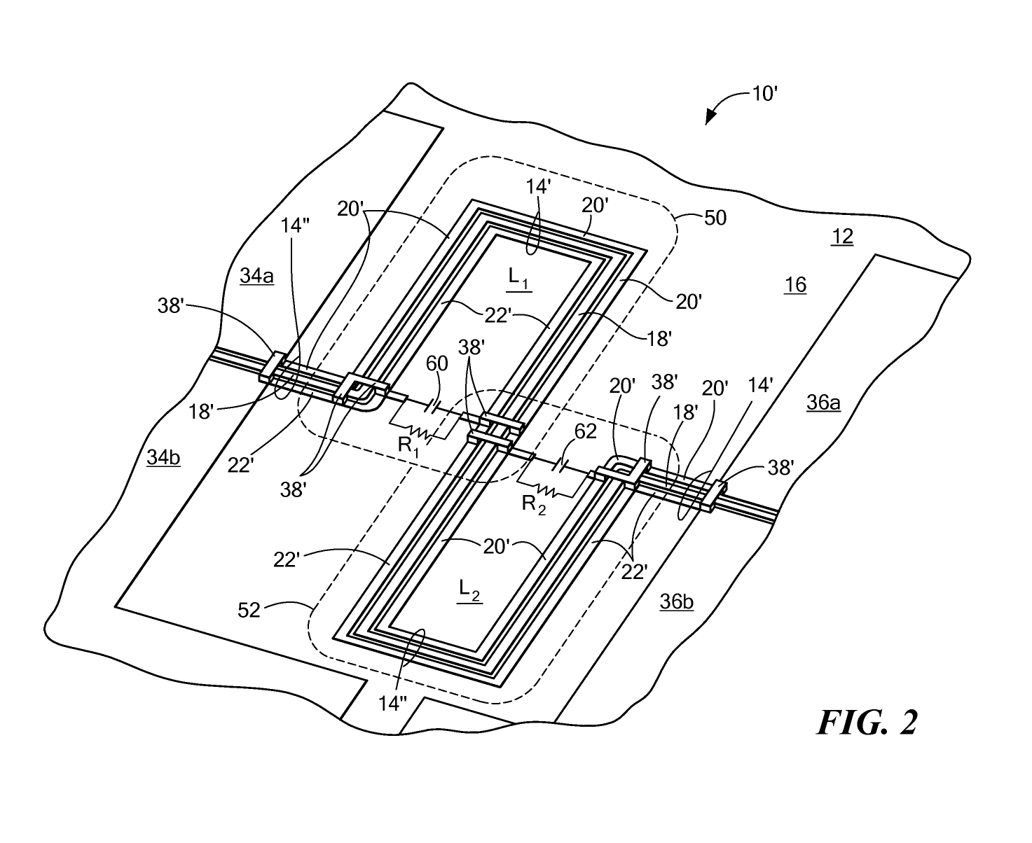

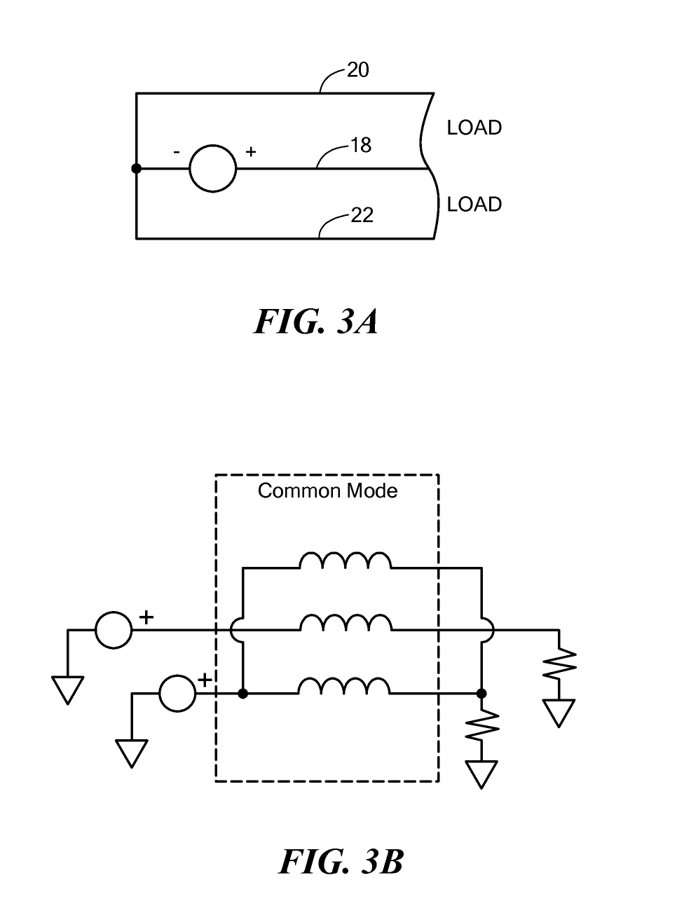

It is noted that the ground plane conductors 34a, 34b are separated from ground plane conductors 36a, 36b by a portion of the surface of the substrate 12. The ground plane conductors 34a, 34b is electrically connected to ground plane conductors 36a, 36b through a resistor R and a capacitor C, the resistor R and the capacitor C being in parallel with the spiral shaped inductors (the spiral shaped conductors 18, 20 and 22). The capacitor C and the spiral shaped inductors (the spiral shaped conductors 18, 20 and 22) form L-C tank circuits tuned to the undesired common mode signals; however, because the CPW transmission line formed by three conductors 18, 20 and 22 provide a differential line (the signal line 18 has its own ground plane lines 20, 22 on either side and on the same surface, differential mode signals pass through the CPW line without being effected by the tank circuits. The resistor R dissipates common mode energy in the tank circuits. FIG. 3A is a schematic diagram of a differential mode equivalent circuit of the transmission line structure of FIG. 2; and FIG. 3B is a schematic diagram of a common mode equivalent circuit of the transmission line structure of FIG. 2.

Referring now to FIGS. 2, a coplanar waveguide transmission line 14′ includes: a center conductor 18′ disposed over the upper surface 16 of the substrate 12; and a pair of ground plane conductors 20′, 22′ disposed over the upper surface 16 of the substrate 12, the center conductor, or signal line, 18′ being disposed between the pair of ground plane conductors, or strips, 20′, 22′, as shown. At least one of the center conductor 18′ and the pair of ground plane conductors 20′, 22′ is configured as a passive reactive element; here all three conductors 18′, 20′ and 22′ are shaped as a meander line inductor, as will be described. It is noted that the ground plane conductors 20′, 22′ are connected by air-bridges 38′ that span over the center conductors 18′, as shown. The structure 10′ may be formed using conventional photolithographic-etching processes. Thus, here there are two, serially connected inductors L1 and L2 formed by each one of the three conductors 18′, 20′ and 22′. Capacitors 60, 62 are connected in parallel with each corresponding one of the inductors L1, L2 forming a pair of serially connected L-C resonant tank, circuits 50, 52, respectively as shown. These tank circuits 50, 52 are tuned to the undesired common mode signals; however, because the CPW transmission line formed by three conductors 18′, 20′ and 22′ provide a differential line (the signal line 18′ has its own ground plane lines 20; 22′ on either side and on the same surface, differential mode signals pass through the CPW line without being effected by the tank circuits 50, 52. Resistors R1 and R2 are connected in parallel with L-C tank circuits 50, 52, respectively, to dissipate common mode energy in the tank circuits 50, 51.

FIG. 3A is a schematic diagram of a differential mode equivalent circuit of the transmission line structure of FIG. 2. FIG. 3B is a schematic diagram of a common mode equivalent circuit of the transmission line structure of FIG. 2.

A number of embodiments of the disclosure have been described. Nevertheless, it will be understood that various modifications may be made without departing from the spirit and scope of the disclosure. Accordingly, other embodiments are within the scope of the following claims.

What is claimed is:

1. A circuit having a CPW transmission line configured to choke common mode microwave signals and pass differential mode microwave signals.

2. A circuit comprising; a CPW transmission line, comprising: a surface; a pair of ground plane conductors disposed on the surface, and a center conductor disposed on the surface between the pair of ground plane conductors, wherein one of the pair of ground plane conductors and the center conductor is configured to choke to common mode microwave signals and the CPW transmission line passes differential mode microwave signals.

3. A transmission line structure, comprising:
a substrate;
a coplanar waveguide transmission line disposed over a surface of the substrate, the coplanar waveguide transmission line, comprising:
a center conductor disposed over a surface of the substrate; and
a pair of ground plane conductors disposed over the surface of the substrate,
the center conductor being disposed between the pair of ground plane conductors; and
wherein the coplanar waveguide structure is configured to provide a different attenuation to an unwanted mode of propagation of propagation from that provided to a desired mode to propagate.

4. The structure recited in claim 3 wherein the undesired mode is a common mode of propagation and the desired mode is a differential mode of propagation.

5. The transmission line structure recited in claim 4 wherein at least one of the center conductor and the pair of ground plane conductors is configured as an inductor reactive element.

6. The transmission line structure recited in claim 5 wherein the pair of ground plane conductors and the center conductor is each spiral shaped.

7. The transmission line structure recited in claim 5 wherein the pair of ground plane conductors and the center conductor is each a meander line.

8. The transmission line structure recited in claim 4 wherein at least one of the center conductor and the pair of ground plane conductors is configured as an inductive reactive element.

9. The transmission line structure recited in claim 3 wherein each one of the center conductor and pair of ground plane conductors provides an inductor to suppress parasitic common mode signal propagation in the center conductor or in either one, or both, of the pair of ground plane conductors.

10. A microwave structure, comprising:
an input section for receiving both a common mode signal and a CPW differential mode signal;
an output section;
a CPW transmission line, having a center conductor disposed between a pair of coplanar ground plane conductors, connected between the input section and the output section, the conductors of the CPW transmission line being configured to provide the common mode signal a different attenuation in passing to the output section than the CPW transmission line provides to the differential mode signal passing between the input section and the output section.

11. The microwave structure recited in claim 10 wherein the center conductor and the pair of ground plane conductors are each configured as an inductor.

12. The microwave structure recited in claim 11 including a capacitor connected in parallel with the inductor.

13. The microwave structure recited in claim 12 wherein the capacitor, the center conductor and the pair of coplanar ground plane conductors are disposed on a common substrate.

14. The transmission line structure recited in claim 10 wherein the pair of ground plane conductors and the center conductor is each spiral shaped.

15. The transmission line structure recited in claim 10 wherein the pair of ground plane conductors and the center conductor is each a meander line,

16. A transmission line structure, comprising.
a substrate;
a coplanar waveguide transmission line disposed over a surface of the substrate, the coplanar waveguide transmission line transmitting balanced mode signals, comprising:
a center conductor disposed over a surface of the substrate; and
a pair of ground plane conductors disposed over the surface of the substrate, the center conductor being disposed between the pair of ground plane conductors microwave; and
wherein at least one of the center conductor and the pair of ground plane conductors is configured to suppresses common mode signals.

17. The microwave structure recited in claim 16 wherein the center conductor and the pair of ground plane conductors are each configured as an inductor.

18. The microwave structure recited in claim 17 including a capacitor connected in parallel with the inductor.

19. The microwave structure recited in claim 18 wherein the capacitor, the center conductor and the pair of coplanar ground plane conductors are disposed on a common substrate.

20. The transmission line structure recited in claim 16 wherein the pair of ground plane conductors and the center conductor is each spiral shaped.

21. The microwave structure recited in claim 17 including a resistor in parallel with the inductor.

22. The microwave structure recited in claim 17 wherein the resistor, the center conductor and the pair of coplanar ground plane conductors are disposed on a common substrate.

23. The microwave structure recited in claim 21 including a capacitor in parallel with the resistor.
